(19) United States
(12) Patent Application Publication
(10) Pub. No.: US 2025/0056214 A1
(43) Pub. Date: Feb. 13, 2025

(54) PROTECTING CAPABILITY INDICATION IN UE INITIATED VISITED PUBLIC LAND MOBILE NETWORK (VPLMN) SLICE-BASED STEERING OF ROAMING (SOR)

(71) Applicant: ZTE Corporation, Shenzhen (CN)

(72) Inventors: Peilin LIU, Shenzhen (CN); Shilin YOU, Shenzhen (CN); Zhen XING, Shenzhen (CN); Yuze LIU, Shenzhen (CN); Wei MA, Shenzhen (CN); Li TIAN, Shenzhen (CN)

(21) Appl. No.: 18/926,081

(22) Filed: Oct. 24, 2024

Related U.S. Application Data
(63) Continuation of application No. PCT/CN2022/125385, filed on Oct. 14, 2022.

(51) Int. Cl. H04W 12/03; H04W 12/0431

(52) U.S. Cl. CPC H04W 12/03; H04W 12/0431

(57) ABSTRACT

Techniques are described to perform network relay security. Multiple methods and an apparatus are proposed to protect the sensitive communication information of users in network communication environment. This application proposes a mechanism for protecting roaming UE capability indication in UE initiated slice-based SoR from attacks such as bidding down attacks. An example communication method includes generating, by a communication device, a request information message that includes a request information to be encrypted by a key, wherein the key is selected from a plurality of key pairs known to the first network node and the communication device, wherein a portion of the request information is transparent to a second network node; and transmitting, from the communication device, the request message to a first network node through the second network node, wherein the request message comprises a key identifier and a user identifier.

### CROSS-REFERENCE TO RELATED APPLICATION

This application is a continuation and claims priority to International Application No. PCT/CN2022/125385, filed on Oct. 14, 2022, the disclosure of which is hereby incorporated by reference herein in its entirety.

### TECHNICAL FIELD

This disclosure is directed generally to network communications.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This application discloses techniques for performing network relay security.

Multiple methods and an apparatus are proposed to protect the sensitive communication information of users in network communication environment.

A first communication method comprising generating, by a communication device, a request information message that includes a request information to be encrypted by a key, wherein the key is selected from a plurality of key pairs known to a first network node and the communication device, wherein a portion of the request information is transparent to a second network node; and transmitting, from the communication device, the request message to the first network node through the second network node, wherein the request message comprises a key identifier and a user identifier.

In some embodiments, the communication device and the second network node are affiliated with a same network.

In some embodiments, the communication device and the first network node are affiliated with different networks.

In some embodiments, the key is selected from a plurality of key pairs known to the first network node and the communication device, wherein each key pair comprises a public key and a private key.

In some embodiments, the key identifier indicates a specific key pair of the plurality of keys pairs.

In some embodiments, the user identifier includes subscription permanent identifier (SUPI).

In some embodiments, each key pair comprises a Home Network Public Key and a Home Network Private Key.

In some embodiments, the key is a Home Network Public Key.

In some embodiments, the network device comprising an access and mobility management function (AMF) device and/or a Unified Data Management (UDM) device.

A second communication method, comprising receiving, by a first network node, a first request message that includes a key identifier and a user identifier, wherein the user identifier is associated with a communication device; and determining, by the first network node in response to the receiving, to selectively send one of: (a) a response message to a second network node, or (b) a second request message to a third network node, based on a decision rule.

In some embodiments, the decision rule comprising deciding whether the communication device is authenticated based on the user identifier.

In some embodiment, the second communication method further comprising sending the response message to the second network node when deciding the communication device is not authenticated, wherein the response message includes a cause of a rejection.

In some embodiments the decision rule comprising checking a capacity information of the communication device when the communication device is authenticated.

In some embodiments, the second method further comprising decrypting the message using a key identified by the key identifier.

In some embodiments, the key is selected from a plurality of key pairs known to the first network node and the communication device, wherein each key pair comprises a public key and a private key.

In some embodiments, the key identifier indicates a specific key pair of the plurality of keys pairs.

In some embodiments, the first request message is encrypted and is transmitted from a communication device to the first network node through the second network node, wherein part of the first request message is transparent to the second network node.

In some embodiments, the user identifier includes subscription permanent identifier (SUPI).

In some embodiments, the first network node and the communication device are affiliated with different networks.

In some embodiments, the first network node and the third network node are affiliated with a same network.

In some embodiments, the second network node and communication device are affiliated with a same network.

In some embodiments, each key pair of the plurality of key pairs comprises a Home Network Public Key and a Home Network Private Key.

In some embodiments, the key is a Home Network Private Key.

In some embodiments, the network node comprising an access and mobility management function (AMF) device, a Unified Data Management (UDM) device, and/or steering of roaming application function (SOR AF).

A third communication method, comprising generating, by a first network node, a response message that includes a response information encrypted by a key, wherein the key is selected from a plurality of key pairs known to the first network node a the communication device; and transmitting, from the first network node, the response message that includes a key identifier to the communication device through a second network node, wherein a portion of the response information is transparent to a second network node.

In some embodiments, the communication device and the second network node are affiliated with a same network.

In some embodiments, the communication device and the first network node are affiliated with different networks.

In some embodiments, each key pair comprises a public key and a private key.

In some embodiments, the key identifier indicates a specific key pair of a plurality of keys pairs known to the communication device and the first network node.

In some embodiments, each key pair comprises a Home Network Public Key and a Home Network Private Key.

In some embodiments, the key is Home Network Public Key.

In some embodiments, the network node comprising an access and mobility management function (AMF) device and/or a Unified Data Management (UDM) device.

A fourth communication method, comprising receiving, by a communication device, an information message comprising a key identifier, wherein the information message is transmitted from a first network node to the communication device through a second network node, wherein the information message is encrypted, and part of the information message is transparent to the second network node; and decrypting, by the communication device, the information message using a key indicated by the key identifier, wherein the key is selected from a plurality of key pairs known to the first network node and the communication device.

In some embodiments, the communication device and the second network node and affiliated with a same network.

In some embodiments, the communication device and the first network node and affiliated with different networks.

In some embodiments, the key is selected from a plurality of key pairs known to the first network node and the communication device, wherein each key pair comprises a public key and a private key.

In some embodiments, the key identifier indicates a specific key pair of the plurality of keys pairs.

In some embodiments, each key pair comprises a Home Network Public Key and a Home Network Private Key.

In some embodiments, the key is a Home Network Private Key.

In some embodiments, the network node comprising an access and mobility management function (AMF) device and/or a Unified Data Management (UDM) device.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 provides an exemplary diagram an architecture of 5G system (5GS) for home routed scenario.

FIG. 2 provides exemplary diagram of a proposed security mechanism for protecting capability indication in UE initiated visited public land mobile network (VPLMN) slice-based steering of roaming (SoR).

FIG. 3 shows an exemplary block diagram of a hardware platform that may be a part of a network device or a communication device.

FIG. 4 shows an example of network communication including a base station (BS) and user equipment (UE) based on some implementations of the disclosed technology.

FIG. 5 shows an example flowchart for facilitating network security between a network device and a remote communication device.

FIG. 6 shows an example flowchart for receiving by a network node a message and reacting based on the indication of the message.

FIG. 7 shows another example flowchart for facilitating network security between a network device and a remote communication device.

FIG. 8 shows an example flowchart for receiving by a network device a message with a key identifier for the network device to select a key and decrypt the message.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in network systems that implemented other protocols.

### 5G System Architecture

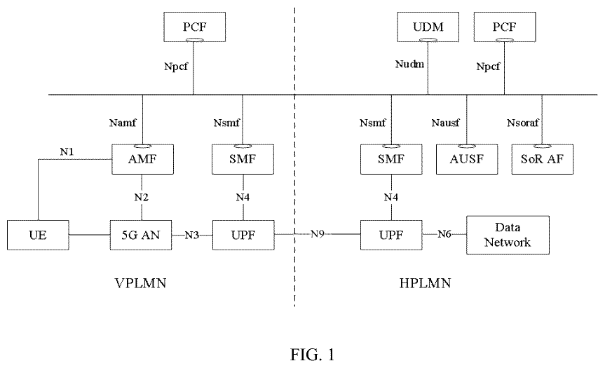

FIG. 1 discloses an architecture of a 5G system (5GS) for home routed scenario in service-based interface representation.

A 5G System architecture consists of the following network functions (NF).

1) The Access and Mobility Management function (AMF) includes functionality such as: user equipment (UE) mobility management, reachability management, connection management, etc. The AMF terminates the radio access network (RAN) control panel (CP) interface (N2) and non-access stratum (NAS(N1)), NAS ciphering and integrity protection. An AMF also distributes the SM NAS to the proper session management functions (SMFs) via N11 interface.

2) The Session Management function (SMF) includes functionality such as: UE IP address allocation & management, Selection and control of UP function, packet data network (PDU) connection management, etc.

3) The User plane function (UPF) is the anchor point for intra radio access technology (Intra-RAT) or inter radio access technology (Inter-RAT) mobility and the external PDU session point of interconnect to Data Network. A UPF can routes and forwards the data packet as the indication from the SMF. A UPF can also buffer the downlink (DL) data when the UE is in idle mode.

4) The Unified Data Management (UDM) stores the subscription profile for the UEs. ARPF is short for Authentication credential Repository and Processing Function. UDM and ARPF belong to the home network and implement together.

5) The Policy Control Function (PCF) generates the police to govern network behavior based on the subscription and indication from application function (AF). PCF also provides policy rules to CP functions (e.g., AMF and SMF) to enforce them.

6) The Authentication Server Function (AUSF) supports authentication for 3GPP access and untrusted non-3GPP access.

7) The Steering of Roaming Application Function (SoR AF) interacts with the 3GPP Core Network to provide Steering of Roaming (SoR) services for a UE.

### Bidding Down Attack

In a network environment disclosed above, network attacks may occur. The bidding down attack is one of the attacks a user may encounter.

For example, in a UE initiated procedure to indicate the UE parameter update (UPU)/SoR capabilities to home network, a new container (transparent for AMF) may be included in a 5G Core Network (5GC) Registration Request from a roaming UE. The new container contains UE information that is pertinent to the request. If the information in the container such as UE capabilities is not protected, the information may be eavesdropped and tampered without authorization by malicious parties.

In such cases, a bidding down attack may occur, making both the UE and network wrongfully believe that the other side cannot support certain security features.

As a result of the bidding down attack, a UE may not be able to access the requested service.

This application proposes a mechanism for protecting roaming UE capability indication in UE initiated slice-based SoR from attacks such as bidding down attacks.

### DETAILED DISCLOSURE

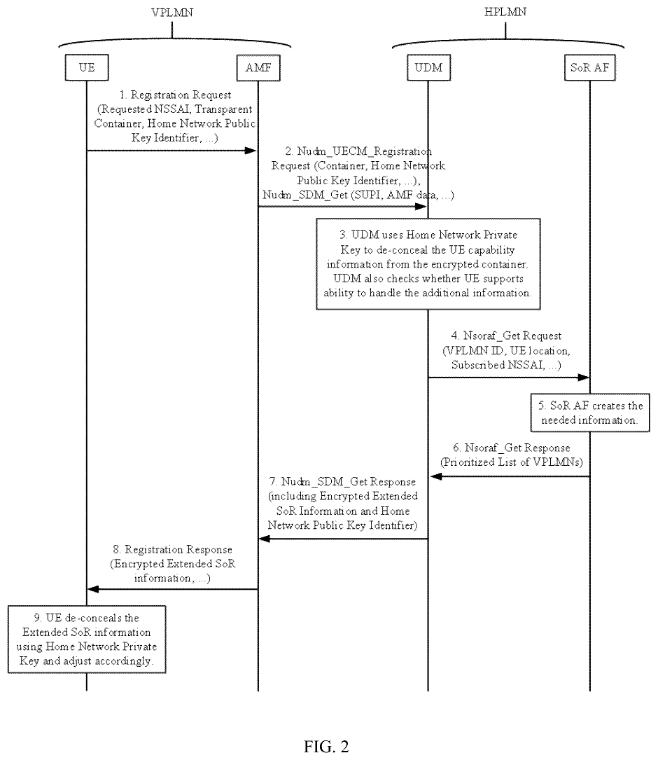

FIG. 2 discloses a proposed security mechanism for protecting capability indication in UE initiated VPLMN slice-based SoR.

Details of FIG. 2 is disclosed below.

1) While roaming in a network, a UE includes a new transparent container in a 5GC Registration Request, when the UE performs Initial Registration or when the UE wants a Home Public Land Mobile Network (HPLMN) to be aware of UE changes e.g., UE capability changes or UE requests new network slices.

This new container is an indication that the UE requests the UDM to provide information relevant to Subscribed/Requested network slice selection assistance information (NSSAI) in the current Visited Public Land Mobile Network (VPLMN) as well as other VPLMNs where the UE is currently located.

The container my include the requested information and includes UE information that is pertinent to the request, e.g., UE capabilities, UE location, Requested NSSAI, etc.

The new transparent container can be encrypted by Home Network Public Key stored in UE, making it transparent for AMF in VPLMN.

While sending the transparent container, the Home Network Public Key Identifier also needs to be included in the registration request.

2) AMF forwards the received container transparently from the UE in the Nudm_UECM_Registration Request towards the UDM.

3) Upon reception of the Nudm_UECM_Registration Request, the UDM uses Home Network Private Key to de-conceal the UE capability information from the encrypted container.

The UDM can also determine whether there is a Subscription Permanent Identifier (SUPI) in the database.

If the SUPI is found in the database, the UDM uses UE capabilities to check whether UE supports ability to handle the additional information.

If the SUPI is not found in the database, the UDM rejects the CM registration request by sending a Nudm_UECM_Registration Response message to AMF, indicating the reason for failure.

4) If the UE does support the additional information, the UDM initiates towards the SOR AF an Nsoraf_SoR_Get Request, which may include VPLMN ID, SUPI of the UE, access type, subscribed Single Network Slice Selection Assistance Information (S-NSSAI), UE location, or UE capability to receive enhanced information.

The UDM passes transparently information included in the container and relevant for the SOR AF to consider.

If the UE does not support the additional information, the UDM rejects the CM registration request on the requested S-NSSAIs by sending a Nudm_UECM_Registration Response message to AMF, indicating the reason of failure.

5) SoR AF creates slice-based SoR information considering the information provided by the UDM and availability of the Subscribed S-NSSAIs in the possible VPLMNs.

To enable the SOR AF to create the slice-based SoR information, the SoR AF scans the possible list of VPLMNs and for each one determines the extent to which the Subscribed NSAAIs are supported.

The SOR AF may then order the information as an example shown below:
VPLMNs supporting all the Subscribed NSSAIs in any order preferred by HPLMN.
VPLMN supporting a subset of the Subscribed NSSAIs in any order preferred by HPLMN.
List of additional networks supporting the Subscribed NSSAIs or Requested NSSAIs not preferred by HPLMN.

6) SoR AF sends the slice-based SoR information to the UDM in a Nsoraf_SoR_Get Response.

7) UDM in HPLMN encrypts the Access and Mobility Subscription data using Home Network Public Key and sends such data in a Nudm_SDM_Get Response message to AMF in VPLMN, together with the Home Network Public Key Identifier. The slice-based SoR information received from SOR AF is included in the Access and Mobility Subscription data. Thus, AMF is transparent to the SoR information.

8) AMF forwards the “steering of roaming information” within the Registration Accept as per current specification.

9) the UE decrypts the slice-based SoR information using the Nome Network Private Key.

If the Allowed NSSAI doesn't include all slices desired by the UE then the UE scans for VPLMN supporting the S-NSSAIs not in Allowed NSSAI and selects and registers accordingly.

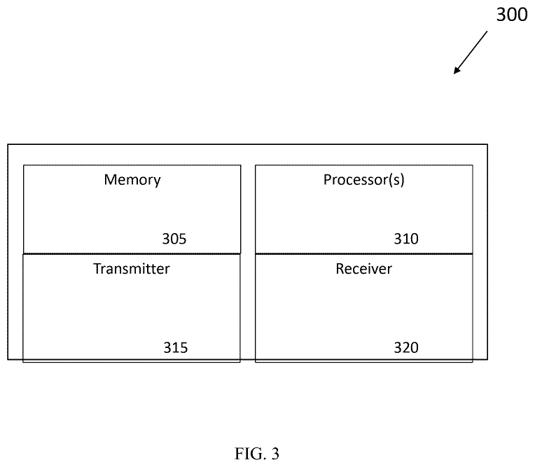

FIG. 3 shows an exemplary block diagram of a hardware platform 300 that may be a part of a network device (e.g., base station) or a communication device (e.g., a user equipment (UE)). The hardware platform 300 includes at least one processor 310 and a memory 305 having instructions stored thereupon. The instructions upon execution by the processor 310 configure the hardware platform 300 to perform the operations described in FIGS. 1 to 2 and in the various embodiments described in this patent document. The transmitter 315 transmits or sends information or data to another device. For example, a network device transmitter can send a message to user equipment. The receiver 320 receives information or data transmitted or sent by another device. For example, user equipment can receive a message from a network device.

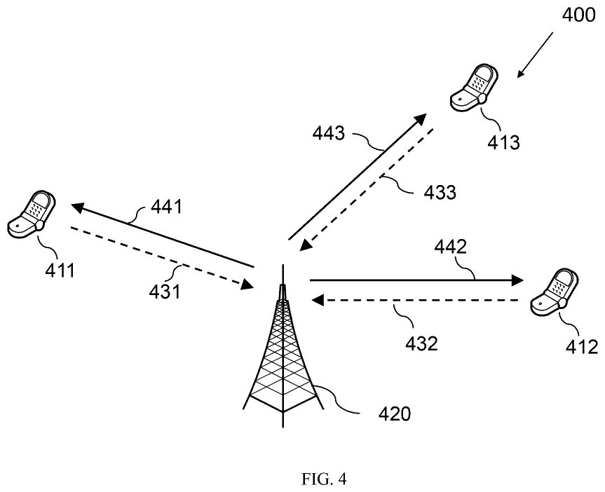

The implementations as discussed above will apply to a network communication. FIG. 4 shows an example of a communication system (e.g., a 5G or NR cellular network) that includes a base station 420 and one or more user equipment (UE) 411, 412 and 413. In some embodiments, the UEs access the BS (e.g., the network) using a communication link to the network (sometimes called uplink direction, as depicted by dashed arrows 431, 432, 433), which then enables subsequent communication (e.g., shown in the direction from the network to the UEs, sometimes called downlink direction, shown by arrows 441, 442, 443) from the BS to the UEs. In some embodiments, the BS send information to the UEs (sometimes called downlink direction, as depicted by arrows 441, 442, 443), which then enables subsequent communication (e.g., shown in the direction from the UEs to the BS, sometimes called uplink direction, shown by dashed arrows 431, 432, 433) from the UEs to the BS. The UE may be, for example, a smartphone, a tablet, a mobile computer, a machine to machine (M2M) device, an Internet of Things (IoT) device, and so on.

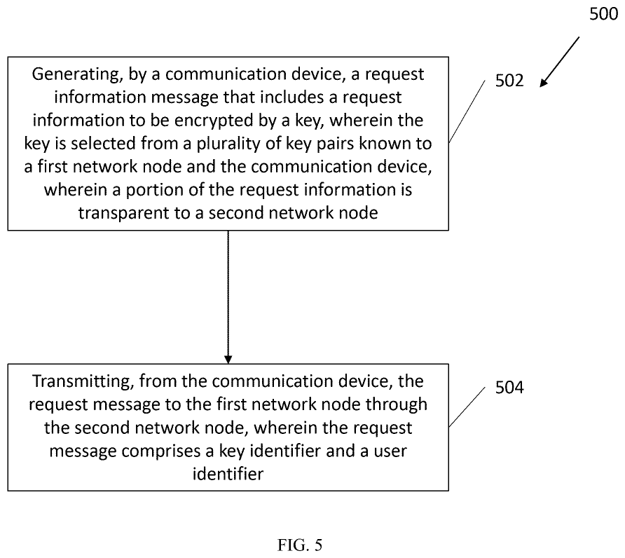

FIG. 5 shows an example flowchart for facilitating network security between a network device and a remote communication device. Operation 502 includes generating, by a communication device, a request information message that includes a request information to be encrypted by a key, wherein the key is selected from a plurality of key pairs known to a first network node and the communication device, wherein a portion of the request information is transparent to a second network node. Operation 504 includes transmitting, from the communication device, the request message to the first network node through the second network node, wherein the request message comprises a key identifier and a user identifier.

In some embodiments, the communication device and the second network node are affiliated with a same network. In some embodiments, the communication device and the first network node are affiliated with different networks. In some embodiments, the key is selected from a plurality of key pairs known to the first network node and the communication device, wherein each key pair comprises a public key and a private key. In some embodiments, the key identifier indicates a specific key pair of the plurality of keys pairs. In some embodiments, the user identifier includes subscription permanent identifier (SUPI). In some embodiments, each key pair comprises a Home Network Public Key and a Home Network Private Key. In some embodiments, the key is a Home Network Public Key. In some embodiments, the network device comprising an access and mobility management function (AMF) device and/or a Unified Data Management (UDM) device.

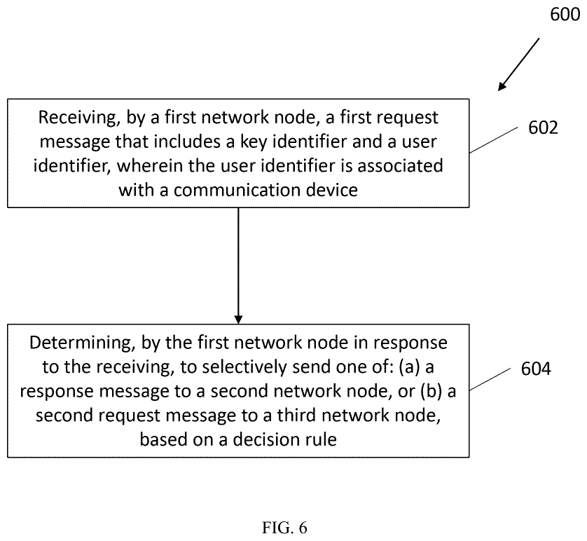

FIG. 6 shows an example flowchart for receiving by a network node a message and reacting based on the indication of the message. Operation 602 includes receiving, by a first network node, a first request message that includes a key identifier and a user identifier, wherein the user identifier is associated with a communication device. Operation 604 includes determining, by the first network node in response to the receiving, to selectively send one of: (a) a response message to a second network node, or (b) a second request message to a third network node, based on a decision rule.

In some embodiments, the decision rule comprising deciding whether the communication device is authenticated based on the user identifier. In some embodiment, the communication method further comprising sending the response message to the second network node when deciding the communication device is not authenticated, wherein the response message includes a cause of a rejection. In some embodiments the decision rule comprising checking a capacity information of the communication device when the communication device is authenticated. In some embodiments, the second method further comprising decrypting the message using a key identified by the key identifier. In some embodiments, the key is selected from a plurality of key pairs known to the first network node and the communication device, wherein each key pair comprises a public key and a private key. In some embodiments, the key identifier indicates a specific key pair of the plurality of keys pairs. In some embodiments, the first request message is encrypted and is transmitted from a communication device to the first network node through the second network node, wherein part of the first request message is transparent to the second network node. In some embodiments, the user identifier includes subscription permanent identifier (SUPI). In some embodiments, the first network node and the communication device are affiliated with different networks. In some embodiments, the first network node and the third network node are affiliated with a same network. In some embodiments, the second network node and communication device are affiliated with a same network. In some embodiments, each key pair of the plurality of key pairs comprises a Home Network Public Key and a Home Network Private Key. In some embodiments, the key is a Home Network Private Key. In some embodiments, the network node comprising an access and mobility management function (AMF) device, a Unified Data Management (UDM) device, and/or steering of roaming application function (SOR AF).

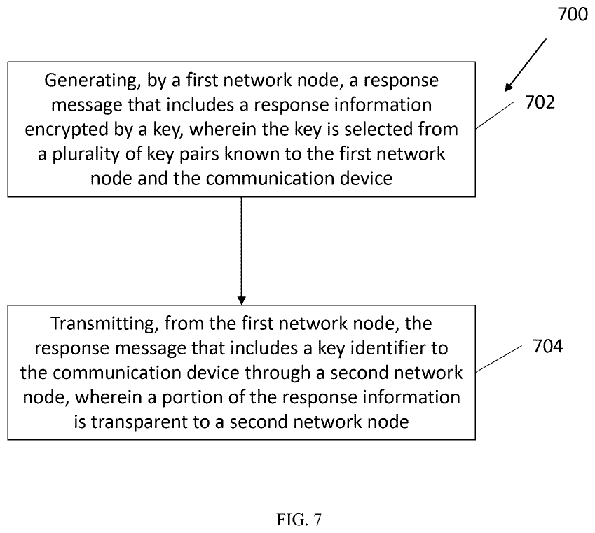

FIG. 7 shows another example flowchart for facilitating network security between a network device and a remote communication device. Operation 702 includes generating, by a first network node, a response message that includes a response information encrypted by a key, wherein the key is selected from a plurality of key pairs known to the first network node and the communication device. Operation 704 includes transmitting, from the first network node, the response message that includes a key identifier to the communication device through a second network node, wherein a portion of the response information is transparent to a second network node.

In some embodiments, the communication device and the second network node are affiliated with a same network. In some embodiments, the communication device and the first network node are affiliated with different networks. In some embodiments, each key pair comprises a public key and a private key. In some embodiments, the key identifier indicates a specific key pair of a plurality of keys pairs known to the communication device and the first network node. In some embodiments, each key pair comprises a Home Network Public Key and a Home Network Private Key. In some embodiments, the key is Home Network Public Key. In some embodiments, the network node comprising an access and mobility management function (AMF) device and/or a Unified Data Management (UDM) device.

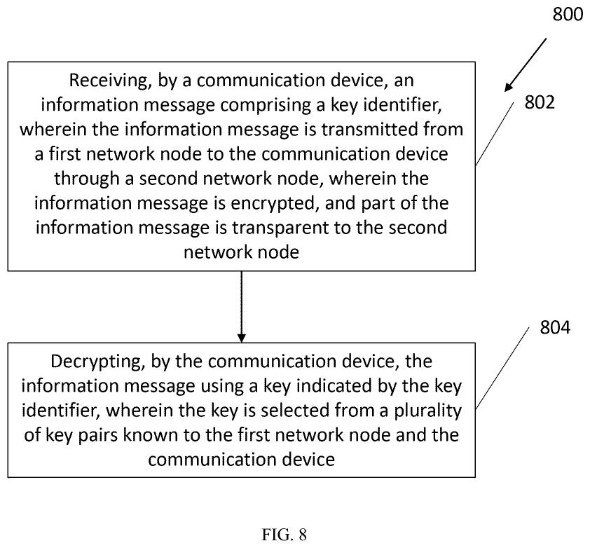

FIG. 8 shows an example flowchart for receiving by a network device a message with a key identifier for the network device to select a key and decrypt the message. Operation 802 includes receiving, by a communication device, an information message comprising a key identifier, wherein the information message is transmitted from a first network node to the communication device through a second network node, wherein the information message is encrypted, and part of the information message is transparent to the second network node. Operation 804 includes decrypting, by the communication device, the information message using a key indicated by the key identifier, wherein the key is selected from a plurality of key pairs known to the first network node and the communication device.

In some embodiments, the communication device and the second network node and affiliated with a same network. In some embodiments, the communication device and the first network node and affiliated with different networks. In some embodiments, the key is selected from a plurality of key pairs known to the first network node and the communication device, wherein each key pair comprises a public key and a private key. In some embodiments, the key identifier indicates a specific key pair of the plurality of keys pairs. In some embodiments, each key pair comprises a Home Network Public Key and a Home Network Private Key. In some embodiments, the key is a Home Network Private Key. In some embodiments, the network node comprising an access and mobility management function (AMF) device and/or a Unified Data Management (UDM) device.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A communication method, comprising:
generating, by a communication device, a request information message that includes a request information to be encrypted by a key,
wherein the key is selected from a plurality of key pairs known to a first network node and the communication device,
wherein a portion of the request information is transparent to a second network node; and
transmitting, from the communication device, the request information message to the first network node through the second network node,
wherein the request information message comprises a key identifier and a user identifier.

2. The method of claim 1, wherein the communication device and the second network node are affiliated with a same network.

3. The method of claim 1, wherein the communication device and the first network node are affiliated with different networks.

4. The method of claim 1, wherein each key pair of the plurality of key pairs comprises a public key and a private key.

5. The method of claim 1, wherein the key identifier indicates a specific key pair of the plurality of keys pairs.

6. The method of claim 1, wherein the user identifier includes subscription permanent identifier (SUPI).

7. The method of claim 1, wherein each key pair of the plurality of key pairs comprises a Home Network Public Key and a Home Network Private Key.

8. The method of claim 1, wherein the key is a Home Network Public Key.

9. The method of claim 1, wherein the first and second network nodes each comprise an access and mobility management function (AMF) device or a Unified Data Management (UDM) device.

10. A communication method, comprising:
receiving, by a first network node, a first request message that includes a key identifier and a user identifier, wherein the user identifier is associated with a communication device;
decrypting, by the first network node, the first request message using a key identified by the key identifier,
wherein the key is selected from a plurality of key pairs known to the first network node and the communication device; and
determining, by the first network node in response to the receiving and the decrypting, to selectively send one of: (a) a response message to a second network node, or (b) a second request message to a third network node, based on a decision rule.

11. The method of claim 10, wherein the decision rule comprises:
deciding whether the communication device is authenticated based on the user identifier;
checking a capacity information of the communication device when the communication device is authenticated; and
in response to deciding when the communication device is not authenticated, send the response message to the second network node, wherein the response message includes a cause of a rejection.

12. The method of claim 10, wherein the first network node and the third network node are affiliated with a same network.

13. The method of claim 10, wherein the key is a Home Network Private Key.

14. The method of claim 10, wherein the first, second, and third network nodes each comprise an access and mobility management function (AMF) device, a Unified Data Management (UDM) device, or a steering of roaming application function (SOR AF).

15. A communication method, comprising:
generating, by a first network node, a response message that includes a response information encrypted by a key,
wherein the key is selected from a plurality of key pairs known to the first network node and a communication device; and
transmitting, from the first network node, the response message that includes a key identifier to the communication device through a second network node,
wherein a portion of the response information is transparent to the second network node.

16. The method of claim 15, wherein the key is a Home Network Public Key.

17. A communication method, comprising:
receiving, by a communication device, an information message comprising a key identifier,
wherein the information message is transmitted from a first network node to the communication device through a second network node,
wherein the information message is encrypted, and part of the information message is transparent to the second network node; and
decrypting, by the communication device, the information message using a key indicated by the key identifier,
wherein the key is selected from a plurality of key pairs known to the first network node and the communication device.

18. The method of claim 17, wherein the key is a Home Network Private Key.
